(19) United States
(12) Patent Application Publication
(10) Pub. No.: US 2006/0033380 A1
(43) Pub. Date: Feb. 16, 2006

(54) Wheel for motor vehicle

(75) Inventor: Mikiya Yamagishi, Anjo-shi (JP)

Correspondence Address: DARBY & DARBY P.C., P. O. BOX 5257, NEW YORK, NY, 10150-5257, US

(73) Assignee: Central Motor Wheel Co., Ltd., Aichi (JP)

(21) Appl. No.: 10/531,812

(22) PCT Filed: Oct. 20, 2003
(86) PCT No.: PCT/JP03/13352

§ 371 Date: Apr. 18, 2005

(30) Foreign Application Priority Data
Oct. 25, 2002 (JP) 2002-310520

(51) Int. Cl. B60B 7/14

(52) U.S. Cl. 301/37.371

(57) ABSTRACT

A cover having deformable narrow spoke portions for partially covering a disk radial portion along a radial direction of the wheel is attached to a wheel base unit. The deformable narrow spoke portions are formed with thin, deformable parts. This permits the deformable narrow spoke portions to follow the deformation of the disk radial portion. Therefore, it is possible to reduce noise produced with external forces received when driving and provide excellent low noise characteristic.

### FIELD OF THE INVENTION

This invention relates to a vehicle wheel consisting of a wheel base unit and a cover attached to the outer side of the wheel base unit.

### BACKGROUND OF THE INVENITON

The wheel for vehicles for example automobiles is configured with a disk portion to which an axle is joined and a rim portion to which a tire is fit. The wheel is made of steel or aluminum. In recent years, the wheel for vehicles is increasingly required of appearance characteristic of external appearance design in addition to mechanical characteristics such as strength, steering stability, and lightweight. This has led aluminum wheels to the mainstream because they can be produced as a single component by casting and have high degree of freedom in appearance and form.

On the other hand, the steel wheels are less expensive than the aluminum wheels and used as general purpose wheels. Many of such steel wheels are provided with a plastic cover attached to their outer side to enhance design characteristic. Here, because only the cover is made to express the design characteristic of the wheel, in most cases it is made to cover the entire surface of the steel wheel so that the steel wheel base unit is invisible from outside. However, because the steel wheel with a cover on the entire surface has a problem in cooling characteristic by heat radiation, a constitution (for example JP-A-2001-10301) has been proposed in which a cover does not obstruct heat radiation holes in the wheel base unit. Furthermore, there are also aluminum wheels provided with a cover. As for such an aluminum wheel, a constitution has been proposed (for example JP-A-H9-193601) in which the aluminum wheel base unit bears the above-mentioned mechanical characteristics while the cover bears the design characteristic, respectively sharing their roles. Incidentally, also with the above constitution, like the steel wheel above, the cover is placed over the entire surface of the wheel base unit, so that the design surface is constituted with the cover only.

In some of the vehicle wheels provided with such a cover, the cover is in tight contact with the wheel base unit without a gap in between.

When a vehicle such as an automobile is running, the wheels of the vehicle are to receive external forces such as loads and bending moments radially from outside through the disk radial portion of the wheel formed between the rim portion and the hub attachment portion where the axle is joined. Therefore, the disk radial portion when driving repeats elastic deformation and vibrates due to such external forces. Here, in case of a vehicle wheel configured with a steel or aluminum wheel base unit provided with a cover made of plastic such as ABS, not only the disk radial portion repeats elastic deformation and vibrates when driving as described above, but also the cover vibrates due to loads and deformation transmitted from the wheel base unit. The vibration of the wheel base unit is different in characteristics such as amplitude and intensity from the vibration of the cover due to differences in material, modulus of elasticity, and natural frequency. As a result, the vibrations of both components cause repeated colliding actions between the cover and the wheel base unit as they collide with and part from each other. Abnormal sound, noise, produced by the colliding actions is a problem associated with the running wheel. Also here, if the wheel base unit and the cover are made to contact each other without a gap, the colliding actions become remarkable by the vibrations of the wheel base unit and the cover and produce large noise when traveling.

This invention is to provide a vehicle wheel having a wheel base unit with a cover that makes it possible to solve the above-described problems, reducing noises produced when traveling and improving design characteristic.

### SUMMARY OF THE INVENTION

This invention relates to a vehicle wheel having a wheel base unit made up of a disk portion and a rim portion, with a cover placed to cover the wheel base unit from its outside, characterized in that the cover has easily deformable narrow spoke portions for partially covering a disk radial portion interconnecting the hub attachment portion of the disk portion to be joined to an axle and the rim portion and that a design surface is constituted with the outside of the easily deformable narrow spoke portions and the exposed outside surface of the disk radial portion. The easily deformable narrow spoke portion of the cover is provided with a relatively thin, easily deformable part for covering approximately middle part of the disk radial portion. Here, “exposed outside surface” of the disk radial portion refers to part of the disk radial portion that is not covered with the easily deformable narrow spoke portions and is exposed outside. Besides, the side of the vehicle wheel that faces outward of the vehicle when attached to the vehicle becomes the design surface of the wheel.

With the above constitution, the easily deformable narrow spoke portions are made in a slender shape to have a small covering area for partially covering the disk radial portion of the wheel base unit, so that they are low in rigidity and easily deformable in comparison with the disk radial portion. Therefore, with the vehicle wheel of this invention, the easily deformable narrow spoke portions of the cover deform due to external forces that they receive when traveling such as radial loads, circumferential loads, torsional forces, and bending moments, and follow the elastic deformation of the disk radial portion that is higher in rigidity than the easily deformable narrow spoke portions. The difference in vibration characteristic between the disk radial portion and the easily deformable narrow spoke portions becomes small. The repeated colliding actions, or butting action, between the cover and the wheel base unit caused by the vibrations of both the components decrease, so that it is possible to reduce noise. It is further possible to reduce frictional actions between the easily deformable narrow spoke portions and the disk radial portion produced with torsional vibration and radial wobble that the wheel receives when traveling and to reduce noise produced with the frictional actions. Incidentally, in case of a cover made of a material that is lower in modulus of elasticity than the wheel base unit, because the easily deformable narrow spoke portions are further lower in rigidity than the disk radial portion, the easily deformable narrow spoke portions deform further well to follow the elastic deformation of the disk radial portion.

Besides, because the easily deformable narrow spoke portions are made in a slender shape for covering part of the disk radial portion, they are flexible and more easily deformable than other portions of the cover. Therefore, even in case the cover is used in a generally practiced constitution in which the cover is attached to the wheel base unit at both the outer circumferential edge and the central part of the cover with the easily deformable narrow spoke portions restricted from deforming at their radially inner and outer ends, they are easy to deform and follow the elastic deformation of the disk radial portion caused with the forces the disk radial portion receives when traveling, and therefore the colliding actions are reduced.

Therefore, such a vehicle wheel of this invention can display excellent low noise characteristic when a vehicle is running. Such a cover according to this invention may preferably employ a constitution in which the easily deformable narrow spoke portions are made, continuous to an outer circumferential edge portion for covering the rim flange portion and to a hub hole covering portion for covering the hub hole located in the center of the wheel base unit, in a shape converging radially from the outer circumferential edge portion to the hub hole covering portion. The cover of this invention may be attached to the wheel base unit using various attaching methods such as using engage-stop claws with coils or plate springs producing urging forces, or attaching to the hub attachment portion using bolts at the same time the hub is secured.

The above constitution uses both the outer side of the easily deformable narrow spoke portions and the exposed outer side of the disk radial portion not covered with the easily deformable narrow spoke portions to form a design surface. Therefore, the design surface can form an axial depth with the easily deformable narrow spoke portions and the disk radial portion, and may become a three-dimensional shape that emphasizes solid appearance. Constituting the design surface of the vehicle wheel by the merger of the cover and the outer side of the wheel base unit as described above can produce unprecedented in-fashion characteristic of the wheel that is actively required of design characteristic in recent years and can further enhance commodity value. Such a vehicle wheel has another excellent advantage: the same wheel base unit using a different shape of cover can easily make a wheel of a different design surface of different appearance according to fashion and taste of users. Thus, the vehicle wheel according to the invention can satisfy both the low noise characteristic and design characteristic at high levels. Incidentally, because the cover according to the invention forms the design surface of the wheel in cooperation with the wheel base unit, it is different from the conventional cover that singly bears the design characteristic.

Because the wheel base unit of the above type of vehicle wheel has relatively a large externally exposed area, heat radiating characteristic of the wheel can be enhanced and cooling characteristic of the brake and the like is also enhanced. Furthermore, because the design surface is constituted by merger of the wheel base unit and the cover, it is less necessary to make the wheel base unit and the cover in complicated external shapes. Therefore, it is advantageous in the manufacture of the wheel base unit and the cover because the constitution of dies is simplified and related costs are reduced, and manufacturing process can be made further efficient.

In the present invention the easily deformable narrow spoke portions of the above cover for partially covering the disk radial portion along radial direction are provided with relatively thin, easily deformable parts that cover approximately the middle part of the disk radial portion.

Here, the disk radial portion is formed to interconnect the hub attachment portion and the rim portion. Therefore, the disk radial portion is restrained with the interconnecting portion, so that the approximate radial central part of the disk radial portion is deformed most greatly. As a result, the colliding action occurs most heavily in the approximately middle part of the disk radial portion. Therefore, according to this invention, the easily deformable narrow spoke portions are formed with easily deformable parts made for covering at least approximately middle part of the disk radial portion. Here, because the easily deformable parts are made thinner than any other parts of the easily deformable narrow spoke portions, they are the parts, lowest in rigidity and easiest to deform, of the easily deformable narrow spoke portions. Therefore, the easily deformable parts can deform to follow the greatest elastic deformation occurring in the approximately middle part of the disk radial portion when traveling. Accordingly the colliding actions caused by vibration when driving can be reduced and noise is effectively reduced. As described above, even in the constitution provided with the easily deformable parts, the easily deformable narrow spoke portions have the function of reducing the colliding actions described above.

As for the above vehicle wheel, a constitution is proposed in which the easily deformable narrow spoke portions of the cover have an inside surface shape that comes in tight, even contact with the covered surface on the outer side of the disk radial portion covered with the easily deformable narrow spoke portions. Because the border between the easily deformable narrow spoke portions and the disk radial portion is visibly recognizable, a gap if present at the border may detract from design beauty. Therefore, causing tight contact between the covered surface of the disk radial portion and the easily deformable narrow spoke portions almost without a gap makes it possible to improve the appearance of the border and the design characteristic of the wheel. Incidentally, it is possible to bring the easily deformable narrow spoke portions and the disk radial portion into appropriately tight contact with each other for example with a constitution in which the cover is secured to the wheel base unit in two portions, one near the wheel center and the other near the rim flange.

The vehicle wheel with the cover in tight contact with the wheel base unit as described above, if constituted in the conventional manner, has a big problem of interference due to the colliding actions, caused by external forces produced when traveling, between the wheel base unit and the cover. According to the invention, however, the cover having the easily deformable narrow spoke portions that are flexible and easily deformable is attached to the vehicle wheel. This makes it possible to reduce the colliding actions between the easily deformable narrow spoke portions and the disk radial portion even with the constitution in which the easily deformable narrow spoke portions and the disk radial portion are in tight contact with each other because the easily deformable narrow spoke portions follow the disk radial portion elastically deformed by forces it receives when driving as described above. Accordingly it is possible to reduce noise produced when driving and provide low noise characteristic.

Here, it is possible to make the inside surface shape of the easily deformable narrow spoke portions covering the disk radial portion to be even with the outside surface of the disk radial portion. In this case, whole or specified area of the inside surface is made to be in tight contact, without a gap, with the covered surface of the disk radial portion. Such easily deformable narrow spoke portions are preferably made for example to be solid or hollow in cross section.

It is also proposed here a constitution of the easily deformable narrow spoke portions having side edges in evenly tight contact with the covered surface of the disk radial portion. In such a constitution, the side edges even with the outside surface are formed in the portion bordering the disk radial portion, so that it is possible, similarly to the above, to improve appearance of the exposed portion of the wheel base unit and design characteristic of the vehicle wheel. Such easily deformable narrow spoke portions maybe made for example with a cross section of U-shape that is open at the side edges. With this constitution, the opening edges, namely both side edges, that cover and in contact with the outside surface of the disk radial portion come in evenly tight contact with the outside surface. In case only one of the opening edges is made to contact the outside surface depending on the shape of the cover, that one is the side edge.

Here, in case the easily deformable narrow spoke portions are in U-shape in cross section, it is preferable that the easily deformable parts are formed on the easily deformable narrow spoke portions so as to cover the approximately middle part of the disk radial portion. That is to say, the easily deformable parts are made relatively thin for example by lowering the height of the U-shape of cross section, so that they can easily follow the greatest elastic deformation of the disk radial portion.

As for such a vehicle wheel, a constitution is proposed in which the disk radial portion of the wheel base unit raises axially outward. Such a constitution, because it can easily bear external forces, such as bending moments and radial loads produced when driving, with relatively large elastic deformation of the disk radial portion, can further improve durability of the vehicle wheel. Even with the above constitution in which the disk radial portion is made in the raised shape that makes a large elastic deformation, the easily deformable narrow spoke portions can easily follow the elastic deformation. In this way it is possible to reduce the colliding actions caused by vibrations of the disk radial portion and the easily deformable narrow spoke portions, reduce noise, and provide low noise characteristic as a whole.

### BRIEF DESCRIPTION OF THE DRAWINGS

FIG. 1 is a plan view of a vehicle wheel 1 related to the invention. FIG. 2 is a perspective view of the vehicle wheel 1. FIG. 3 shows a section A-A′ of the vehicle wheel 1 in FIG. 1. FIG. 4 shows a section B-B′ of the vehicle wheel 1 in FIG. 1. FIG. 5 is a perspective view of the wheel base unit 2 of the vehicle wheel 1. FIG. 6 is a perspective view of the cover 3 of the vehicle wheel 1. FIG. 7 is a sectional view of the cover 3 attached to the wheel base unit 2. FIG. 8 is a perspective view of a cover 3′ as another embodiment of the invention. FIG. 9 is a sectional view of the cover 3′ attached to the wheel base unit 2. FIG. 10 is a perspective view of another vehicle wheel 51 related to the invention.

### DETAILED DESCRIPTION OF THE INVENTION

Embodiments of the invention are described in reference to appended drawings.

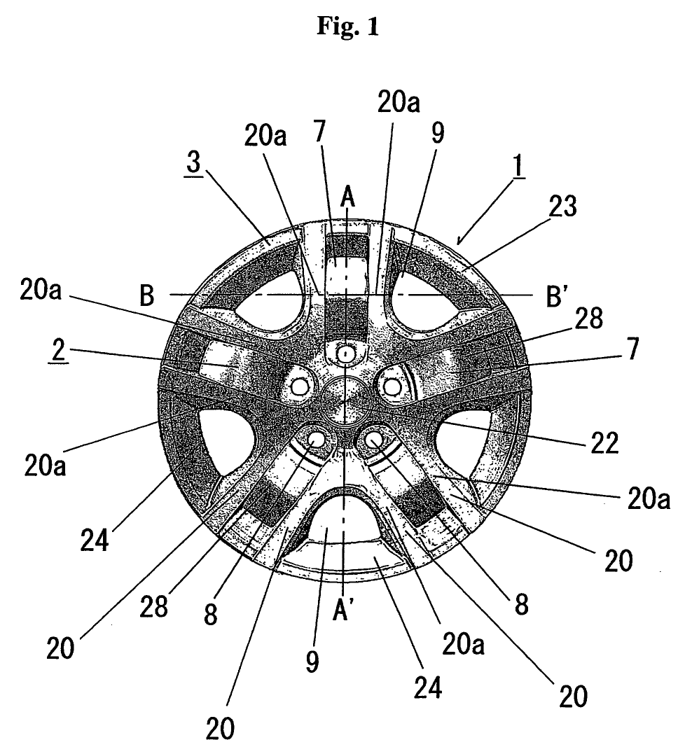

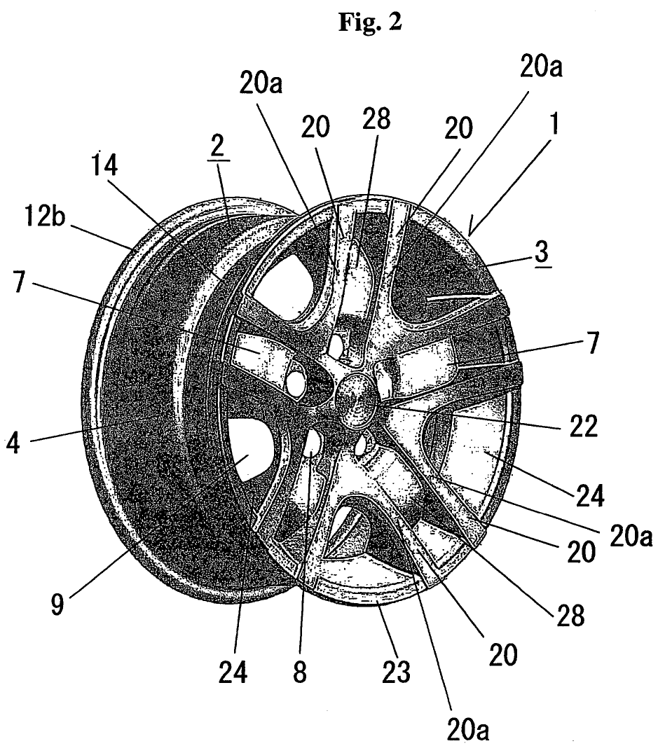

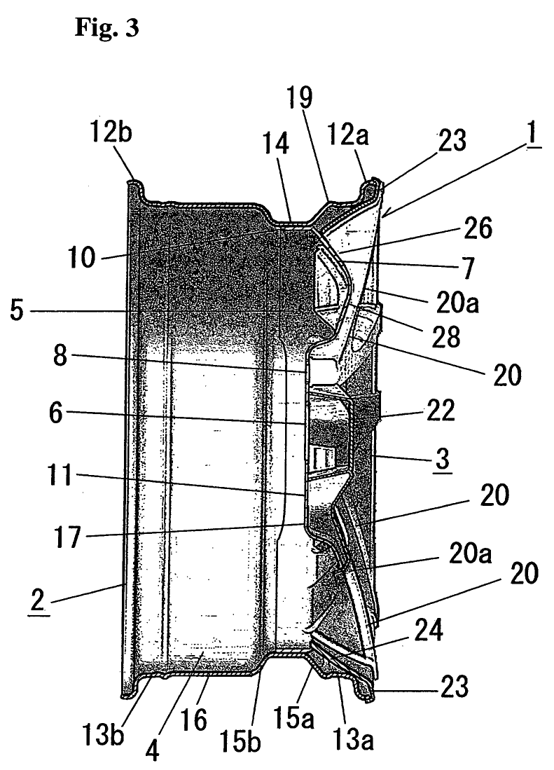

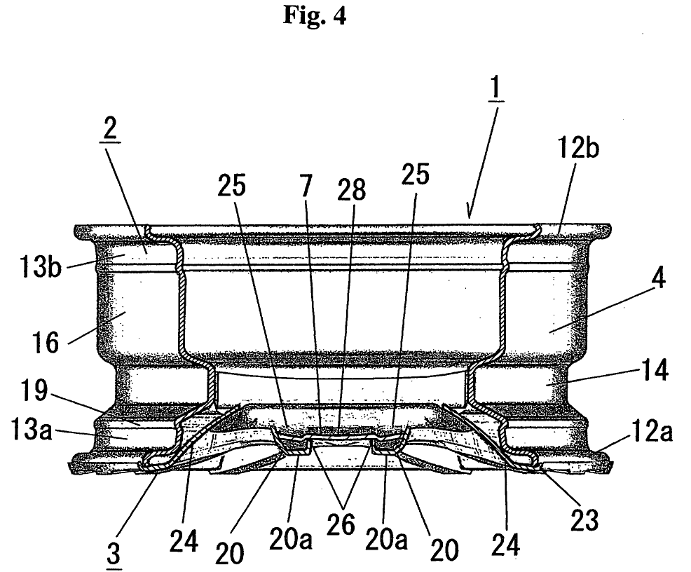

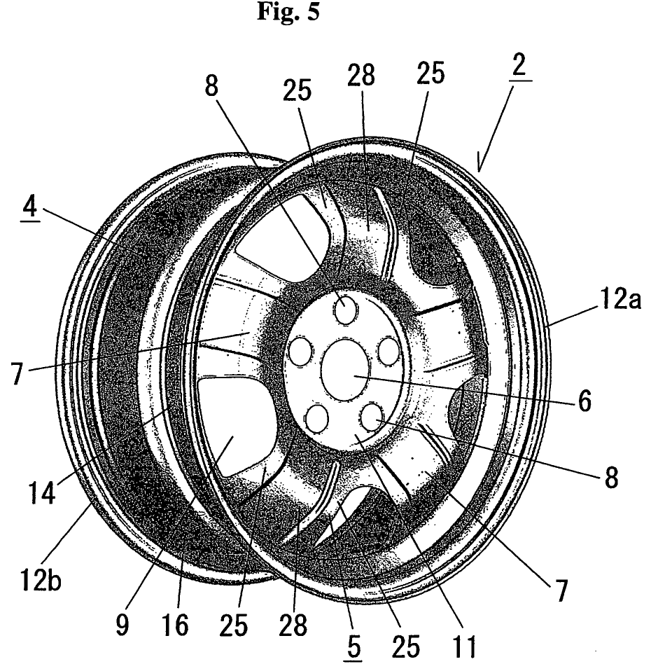

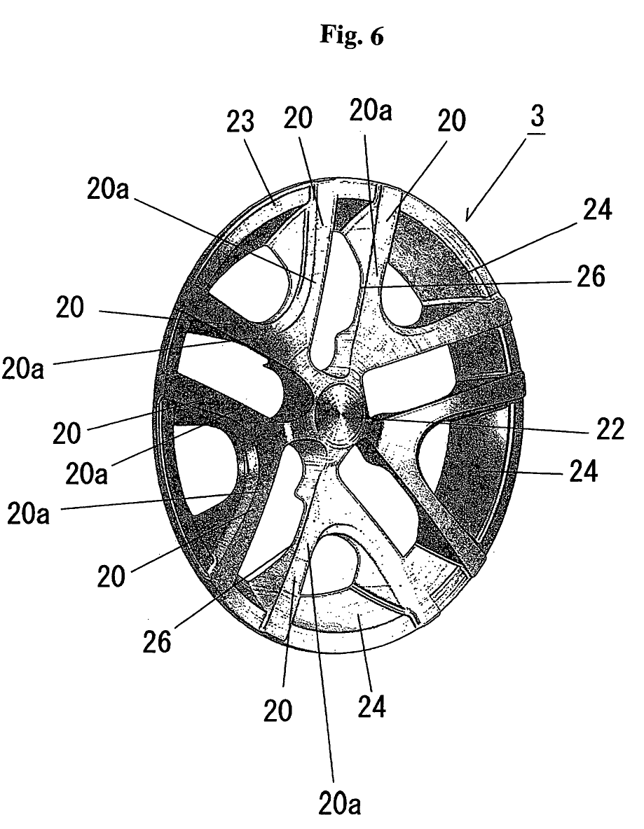

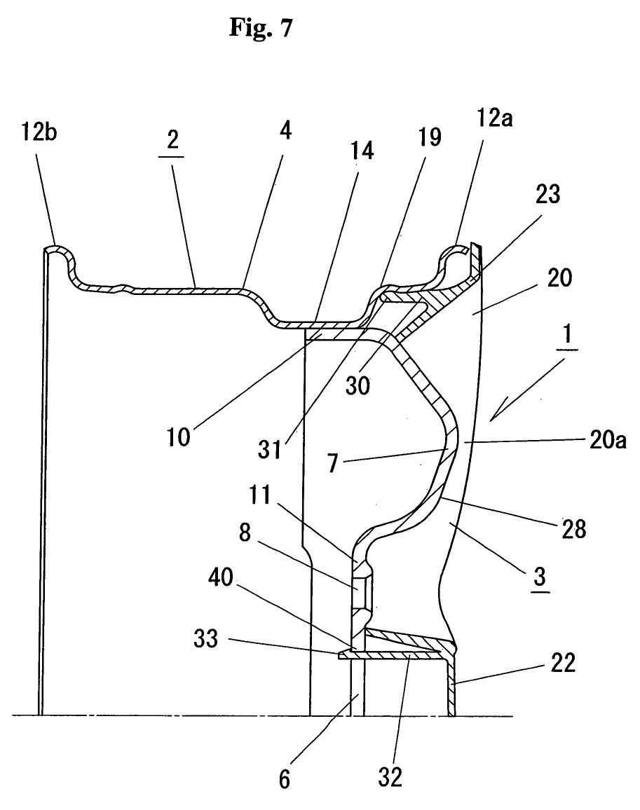

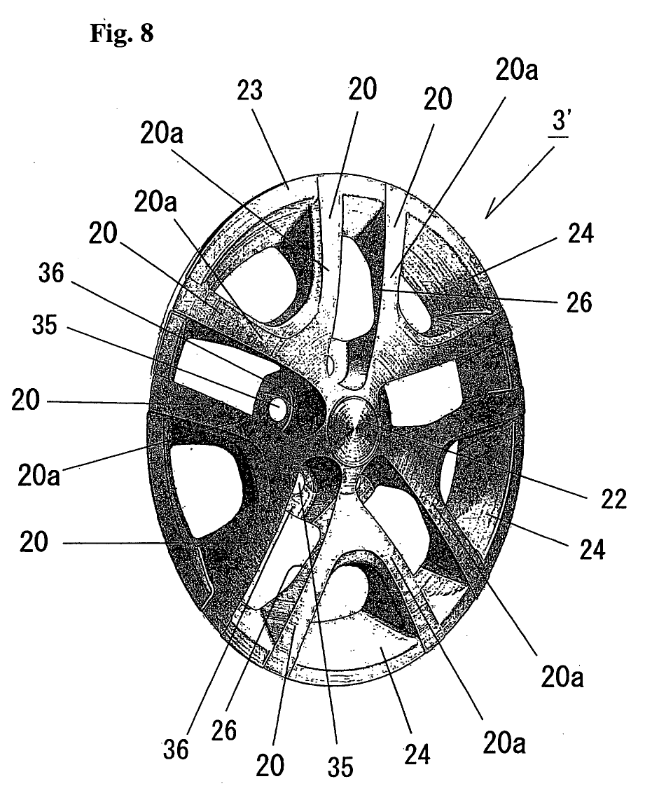

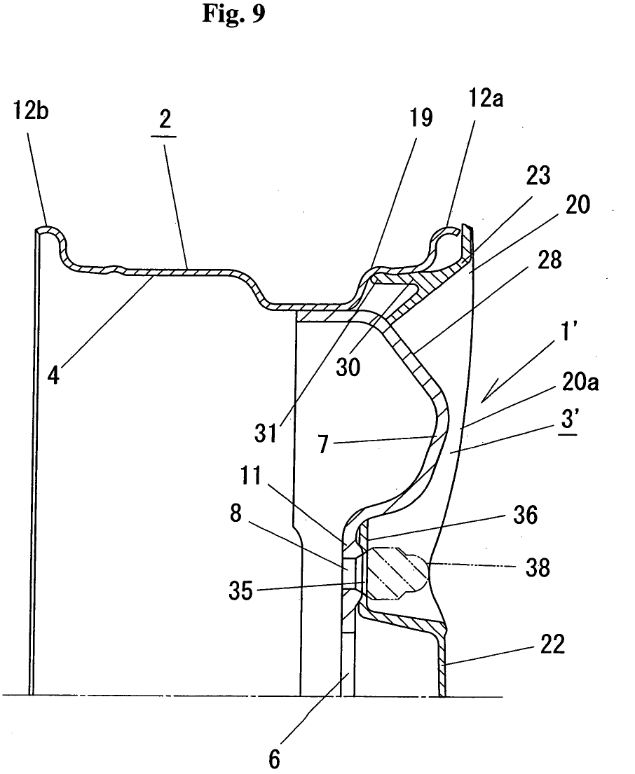

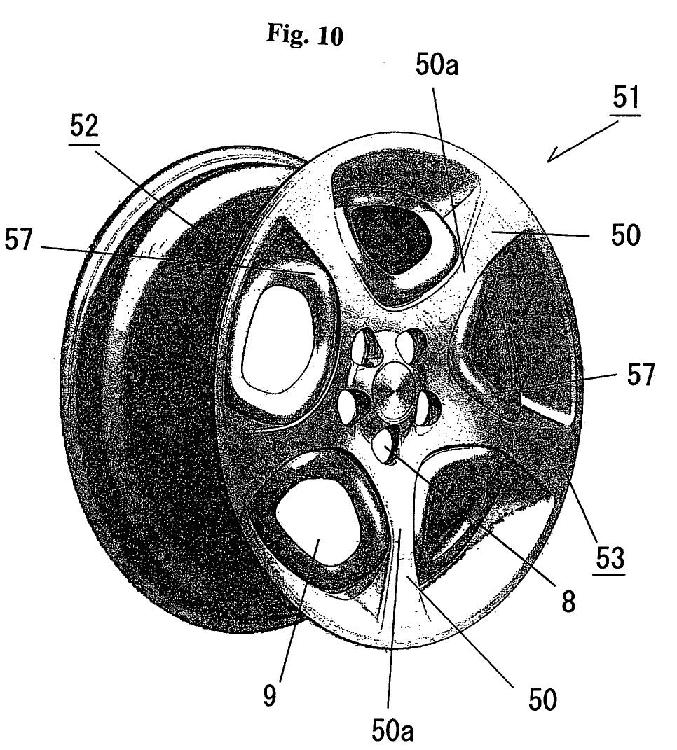

FIG. 1 is a plan view as seen from outside a vehicle wheel 1 for use in automobiles, with an ABS resin-made cover 3 attached to a steel wheel base unit 2. FIG. 2 is a perspective view of the vehicle wheel 1. The vehicle wheel 1 is configured with the wheel base unit 2 to which is attached the cover 3 with a pair of easily deformable narrow spoke portions 20, 20 to cover both side areas (covered surfaces 25) of the outside surface of each disk radial portion 7 along radial direction.

The wheel base unit 2 constituting the vehicle wheel 1 is described in reference to FIG. 3 (section A-A′ in FIG. 1) as the vertical sectional view of the vehicle wheel 1, and to FIG. 5 as the oblique view of the wheel base unit 2. The wheel base unit 2 is of the so-called two-piece type configured with a wheel rim to be a rim portion 4 and a wheel disk to be a disk portion 5. The wheel base unit 2 is made as a single component by fitting the disk flange portion 10 of the wheel disk (disk portion 5) to the inside circumferential surface of the drop portion 14 of the wheel rim (rim portion 4) and fillet-welding the fore-end area of the disk flange portion 10 to the drop portion 14. The fillet weld may be made by any method of known art such as arc welding, laser welding, and the like.

The disk portion 5 has in its center a hub hole 6. Five bolt holes 8 are provided radially outside the hub hole 6 at even circumferential intervals. Disk radial portions 7 of a shape swelling outward from radially outer side of the bolt holes 8 are provided in a radial pattern in five positions, with heat radiation holes 9 among the disk radial portions 7 adjacent one another. The disk flange portion 10 nearly parallel to the axis of the disk portion 5 is formed on radially outer side of the disk radial portions 7 and the heat radiation holes 9. Radially inner side of the disk radial portions 7 is a hub attachment portion 11. The reverse side of the hub attachment portion 11 is formed with a hub attachment surface 17 to be connected to a hub of an axle.

The opening edges on both sides of the rim portion 4 are formed with rim flange portions 12a, 12b for supporting side wall portions of a tire. The rim flange portion 12a to be on the outer side when attached to the vehicle is continuously formed with a bead seat portion 13a for the bead of the tire to seat on. The flange portion 12b on the inner side is continuously formed with a bead seat portion 13b. Toward the wheel's inner side of the outside bead seat portion 13a is provided a drop portion 14, through a well portion 15a rising from the drop portion 14 in the wheel's radial direction, into which the tire bead is to be dropped when the tire is attached. Toward the wheel's inner side of the drop portion 14 is continuously formed a ledge portion 16 through the well portion 15b. The ledge portion 16 is continuously formed with the inside beat seat 13b. Here, the beat seat portions 13a, 13b, and the ledge portion 16 are made to be nearly parallel to the wheel axis. The connecting portion between the outside bead seat portion 13a and the well portion 15a is provided with a circumferential hump portion 19 raised radially outward. Along the inside circumference of the hump portion 19 is formed a recess (See FIG. 7).

Next, the cover 3 attached to the above wheel base unit 2 is described in reference to FIGS. 1 through 3, and 6. A hub hole covering portion 22 for covering the hub hole 6 of the wheel base unit 2 is formed in the center of the cover 3. The peripheral edge of the cover 3 is formed with a periphery covering portion 23 for covering the rim flange portion 12a of the wheel base unit 2. A pair of easily deformable narrow spoke portions 20, 20 are provided, to cover both side areas (covered surfaces 25) of the outside surface of the disk radial portion 7 along the radial direction, extending in a radial pattern from the hub hole covering portion 22 to the periphery covering portion 23. Incidentally, the pair of easily deformable narrow spoke portions 20, 20 are provided in mirror symmetry on both sides of the radial line in the middle between them (center of the disk radial portion 7). The easily deformable narrow spoke portions 20, 20 are respectively provided with easily deformable parts 20a, 20a to cover the most raised part located in about the middle of the disk radial portion 7. An opening circumference wall 24 approximately formed in the shape of the heat radiation hole 9 is formed for each heat radiation hole 9 to cover the edge of the heat radiation hole 9 of the wheel base unit 2, and extends from the two easily deformable narrow spoke portions 20, 20 covering the disk radial portions 7, 7 adjacent one another, from the periphery covering portion 23, and from the hub hole covering portion 22, toward the inside of the heat radiation hole 9. The opening circumference wall 24 does not hinder heat radiation through the heat radiation hole 9 of the wheel base unit 2, so that the vehicle wheel 1 provides excellent cooling characteristic even if the cover 3 is attached.

The easily deformable narrow spoke portions 20 as shown in FIG. 4 (section B-B′ in FIG. 1) is made in a U-shape in cross section. A side edge 26 in tight contact with the covered surface 25 of the wheel base unit 2 is formed at one U-shape opening edge located on the inner side of the disk radial portion 7. The end face of the side edge 26 is made in the same shape as the covered surface 25. In this embodiment, the U-shape opening edge, opposite the side edge 26, of the easily deformable narrow spoke portion 20 is continuously formed with the opening circumference wall 24. The reverse side extending from the U-shape opening edge to the opening circumference wall 24 is made to contact with the side edge of the disk radial portion 7.

In this embodiment as described above, the easily deformable narrow spoke portions 20, 20 covering the disk radial portion 7 are formed with the easily deformable parts 20a, 20a to cover the most raised portion located in about the middle of the disk radial portion 7. That is, because the most raised portion located in about the middle of the disk radial portion 7 and raised outward in the wheel axis direction deforms the most by vibration received when driving, the easily deformable parts 20a are used to cover about the middle portion. The easily deformable parts 20a, 20a are formed along about the radially middle portion of the easily deformable narrow spoke portions 20, 20, in U-shape in cross section as shown in FIG. 4. The easily deformable parts 20a, 20a are made, because they cover the most raised portion of the disk radial portion 7, are made in low profile with low-height side walls of the U-shape cross section (see FIGS. 3 and 7). As a result, the easily deformable parts 20a are the lowest in rigidity and the most deformable in the easily deformable narrow spoke portions 20.

The cover 3 as shown in FIG. 7 is formed with five peripheral attachment lugs 30, at equal circumferential intervals, extending inward from the inside surface of the periphery covering portion 23. The fore-end of the peripheral attachment lug 30 is formed with an engage-stop claw 31 to be engage-stopped with a recess on the reverse side of the hump portion 19 of the wheel base unit 2. The peripheral attachment lug 30 is made to a length so that the periphery covering portion 23 does not contact with the rim flange portion 12a of the wheel base unit 2 when the cover 3 is installed and that a balance weight (not shown) attached to the rim flange portion 12a does not come into contact and interfere with the periphery covering portion 23. Inside the hub hole covering portion 22 of the cap 3, a hole attachment lug 32, with its fore-end formed with a hole engage-stop claw 33 to be engage-stopped with an opening edge 40 of the hub hole 6, is formed to project inward. As the engage-stop claw 31 of the peripheral attachment lug 30 is engage-stopped with the recess on the reverse side of the hump portion 19 and also as the hole engage-stop claw 33 of the hole attachment lug 32 is engage-stopped with the opening edge 40, the cover 3 is attached to the wheel base unit 2. Here, because the peripheral attachment lug 30 and the hole attachment lug 32 are respectively radially urged to be engage-stopped, the cover 3 is secured with the urging force to the wheel base unit 2 and the side edges 26, 26 of the easily deformable narrow spoke portions 20, 20 come into tight contact with the covered surface 25 of the disk radial portion 7. Incidentally, the peripheral attachment lug 30 and the hole attachment lug 32 are not shown in FIGS. 1 through 4, and 6.

As described above, it is possible to make the cover 3 less likely to come off the wheel base unit 2 by securing it to the wheel base unit 2 in both the radially central and peripheral areas of the wheel. Because the side edges 26, 26 of the easily deformable narrow spoke portions 20, 20 come into tight contact with the covered surface 25 of the disk radial portion 7, visual impression of the border between the easily deformable narrow spoke portions 20, 20 and the disk radial portion 7 seen on the exposed portion 28 of the wheel base unit 2 is improved to further enhance the design beauty. This cover 3 provides still another excellent advantage that is tight contact without a gap between the easily deformable narrow spoke portions 20, 20 and the disk radial portion 7 prevents water such as rain water from finding its way into the interior of the easily deformable narrow spoke portions 20, 20 of the U-shape cross section and appropriately prevents deterioration due to corrosion.

Design surface of such a vehicle wheel 1 made up of the wheel base unit 2 with the cover 3 attached thereto is constituted with the cover 3 and the exposed portion 28, not covered with the cover 3, of the wheel base unit 2. Such a design surface produces a three-dimensional form excellent solid appearance because a depth is produced with the easily deformable narrow spoke portions 20, 20 of the cover 3 and the exposed portion 28 of the disk radial portion 7 visible between the easily deformable narrow spoke portions 20, 20. Solid appearance of the vehicle wheel 1 is further emphasized as the easily deformable narrow spoke portions 20, 20 of the cover 3 are shaped to slope outward in the wheel axis direction from the hub hole covering portion 22 toward the periphery covering portion 23 (see FIG. 3). In this way, this vehicle wheel 1 provides excellent design characteristic with the design surface made in a complicated, three-dimensional shape not found in conventional constitution. Incidentally, the exposed portion 28 appearing between the pair of easily deformable narrow spoke portions 20, 20 includes the bolt holes 8.

The above vehicle wheel 1 with a tire attached was subjected to a dynamic radial fatigue test (JIS D 4103) and a dynamic cornering fatigue test (JIS D 4103). Here, in the radial load durability test, a radial load is applied to a tire-equipped wheel rotating at a constant speed. In the rotary bending fatigue test, a bending moment is applied to the hub attachment surface of the wheel. The above tests verified that the vehicle wheel 1 of this embodiment has sufficient durability performance. That is, external forces exerted to the vehicle wheel 1 in the fatigue test exert load stresses to the area between the rim portion 4 for fitting the tire and the hub attachment portion 11 for attaching an axle. However, the load stresses are easily borne by the elastic deformation of the disk radial portion 7 raised outward of the wheel base unit 2.

Here, a vehicle wheel of conventional constitution (not shown) was prepared as a comparative example in which entire surface of the wheel base unit 2 is covered with a plastic cover. During the above tests, sound volumes produced with the comparative sample wheel and the vehicle wheel 1 of this embodiment were measured. As a result, the vehicle wheel 1 of this embodiment proved to produce less volume of sound to provide low noise characteristic in comparison with the example wheel. This is understood as follows. The easily deformable parts 20a, 20a of low rigidity formed in the middle parts of the easily deformable narrow spoke portions 20, 20 come in tight contact with the middle, most deformable part of the disk radial portion 7 raised outward in the wheel axis direction. Therefore, the easily deformable parts 20a, 20a of the easily deformable narrow spoke portions 20, 20 deform easily to follow the elastic deformation that occurs in the middle part of the disk radial portion 7. As a whole, colliding actions, repeated collisions, between the disk radial portion 7 and the easily deformable narrow spoke portions 20, 20, are reduced. In this way, this embodiment reduces the colliding actions to efficiently provide low noise characteristic.

Even with a constitution in which the cover 3 is secured so that the side edge 26 of the easily deformable narrow spoke portion 20 is in tight contact with the covered surface 25 of the disk radial portion 7, the easily deformable narrow spoke portion 20 can easily follow the disk radial portion 7, so that noise reduction effect is obtained.

As described above, the vehicle wheel 1 according to this embodiment consists of the wheel base unit 2 to which is attached the cover 3 having the easily deformable narrow spoke portion 20 that covers the disk radial portion 7. Therefore, the vehicle wheel 1 exhibits low noise characteristic when driving. Besides, the design surface made up of the easily deformable narrow spoke portions 20, 20 of the cover 3 and the exposed outer surface of the wheel base unit 2 exhibits superior design characteristic excellent in solid appearance not found in conventional wheels. Furthermore, because the side edges 26 of the easily deformable narrow spoke portions 20, 20 are in tight contact with the covered surface 25 of the disk radial portion 7, design beauty is further improved. Even in a constitution in which the easily deformable narrow spoke portions 20, 20 are in tight contact with the disk radial portion 7, the low noise characteristic is provided. Moreover, even in a constitution in which the disk radial portion 7 is formed in raised shape to improve durability of the wheel, the easily deformable parts 20a can easily deform to follow the large elastic deformation of the disk radial portion 7.

Because the design surface of the above vehicle wheel 1 is constituted by the merger of the cover 3 and the wheel base unit 2, each component need not be of much complicated shape. Therefore, it is possible to simplify manufacturing process of both the cover 3 and the wheel base unit 2. This is another excellent advantage of further improving production efficiency of the vehicle wheel 1.

As described above, this embodiment is constituted that the easily deformable narrow spoke portion 20 is provided with the easily deformable part 20a to cover the most raised portion located in about the middle of the disk radial portion 7 so that the easily deformable narrow spoke portion 20 as a whole can fulfill its function. Here, the thin shape of the easily deformable part 20a may be realized by, besides lowering the side walls of the U-shape cross section as described above, reducing the wall thickness of each wall constituting the U-shape cross section, or widening the distance between the side walls of the U-shape cross section.

It is also possible to make the easily deformable narrow spoke portion of a solid cross section. Even with such a cover having easily deformable narrow spoke portions of the solid cross section, the same effect as with the above embodiment is provided. Incidentally, it is also possible that the easily deformable narrow spoke portion of the solid cross section has the easily deformable part described above.

Another constitution different from that of the above embodiment is also possible in which the easily deformable parts are not provided and the easily deformable narrow spoke portions are formed so that the spoke portions as a whole can deform to follow the elastic deformation of the disk radial portion 7. For example, the easily deformable narrow spoke portions are formed in a thin shape as a whole along the raised shape of the disk radial portion 7 so that the entire easily deformable narrow spoke portions can follow the disk radial portion 7. Such a constitution can also reduce the colliding actions and display low noise characteristic.

The cover 3 according to the above embodiment is constituted that the peripheral attachment lug 30 and the hole attachment lug 32 are respectively made to engage with the inside circumferential recess of the hump portion 19 and the opening edge 40 of the hub hole 6 of the wheel base unit 2. Another cover 3′ of a different constitution may also be made as shown in FIG. 8 in which a hole seat surface 36 is formed on the radially outer side of the hub hole covering portion 22 between a pair of the easily deformable narrow spoke portions 20, 20, with the hole seat surface 36 bored with a cover holding hole 35 communicated with the bolt hole 8 of the wheel base unit 2. The cover 3′ is formed like the above embodiment with the peripheral attachment lug 30 (not shown in FIG. 8). To attach the cover 3′, the cover holding hole 35 is aligned with the bolt hole 8 as shown in FIG. 9 and the peripheral attachment lug 30 is made to engage with the inside circumferential recess of the hump portion 19. When the vehicle wheel 1′ with the cover 3′ is installed to an automobile, a bolt (not shown) projecting from the hub of the automobile projects from the inside of the wheel 1′ to the outside of the cover holding hole 35. Then the bolt is tightened to the hole seat surface 36 using a specified nut 38. In this way, the vehicle wheel 1′ is secured to the axle, the cover 3′ is secured to the wheel base unit 2, and the side edge 26 of the easily deformable narrow spoke portion 20 comes into tight contact with the covered surface 25 of the disk radial portion 7. Also the above constitution, like the above embodiment, can display excellent design characteristic and low noise characteristic.

The above embodiment is constituted with the wheel base unit 2 to which is attached the cover 3 having the pair of easily deformable narrow spoke portions 20, 20 for covering both side areas of the disk radial portion 7. Another vehicle wheel 51 of a different constitution may also be made as shown in FIG. 10 in which a cover 53 having easily deformable narrow spoke portions 50 is attached to a wheel base unit 52, with the easily deformable narrow spoke portion 50 covering the central area (covered surface) extending in the radial direction of the disk radial portion 57 of the wheel base unit 52. The easily deformable narrow spoke portion 50 here, like the above embodiment, is formed with an easily deformable part 56 in about the middle of the disk radial portion 57. Also such vehicle wheel 51, like that of the above embodiment, shows superior design characteristic and low noise characteristic.

This invention is not limited to the above embodiment but may be embodied in various forms without departing from the spirit of the invention. Besides the example constitutions of the above embodiments in which the ABS resin-made ornament cover 3 is attached to the steel-made wheel base unit 2, the vehicle wheel 1 may be otherwise constituted in which the cover 3 made of plastic or aluminum is attached to the wheel base unit 2 made of aluminum or magnesium.

A: The vehicle wheel according to this invention is constituted with the wheel base unit to which is attached the cover having easily deformable narrow spoke portions for partially covering from outside the disk radial portions along radial direction of the wheel. Design surface is constituted with the outside surface of the easily deformable narrow spoke portions and the exposed outside surface of the disk radial portions. Therefore, the following effects are provided.

a: The easily deformable narrow spoke portion can deform to follow the elastic deformation of the disk radial portion of a high rigidity relative to the easily deformable narrow spoke portion due to external forces the disk radial portion receives when driving a vehicle. Therefore, colliding actions between the disk radial portion and the easily deformable narrow spoke portion are reduced to reduce generation of noise.

b: The design surface is made with the merger of the cover and the outside surface of the wheel base unit to provide excellent design characteristic with emphasized solid appearance. Therefore, unprecedented fashionableness is produced to further enhance commodity value.

c: In this way the vehicle wheel according to this invention brings about coexistence of excellent low noise characteristic and superb design characteristic.

B: With the constitution in which the easily deformable narrow spoke portion has relatively thin, easily deformable parts covering the approximately middle portion, the easily deformable parts, that deform most easily, of the easily deformable narrow spoke portion can deform to follow the elastic deformation of the disk radial portion. Therefore, it is possible to reduce noise efficiently.

C: With the constitution in which the easily deformable narrow spoke portion has an inside surface shape made to come into evenly tight contact with the covered surface, outside surface of the disk radial portion, to be covered with the easily deformable narrow spoke portion, the covered surface of the disk radial portion comes into tight contact with the easily deformable parts almost without a gap, so that design beauty of the wheel is enhanced. This constitution also displays both excellent low noise characteristic and superior design characteristic as described above.

D: With the constitution in which the easily deformable narrow spoke portion has side edges that come into evenly tight contact with the covered surface of the disk radial portion, it is possible, like the above description, to provide both excellent low noise characteristic and superior design characteristic.

E: With the constitution in which the disk radial portion of the wheel base unit is shaped to be raised radially outward, it is possible to bear external forces produced when driving through the swelled shape of the disk radial portion as it makes relatively large elastic deformation, so that durability of the vehicle wheel is further improved. Because the easily deformable narrow spoke portions can also deform to follow such elastic deformation of the disk radial portion, it is possible to reduce colliding actions and provide low noise characteristic.

1. A vehicle wheel comprising:
a wheel base unit having a disk portion and a rim portion; and
a cover attached to the wheel base unit portion,
wherein the cover has deformable narrow spoke portions for partially covering, along a radial direction of the wheel, a disk radial portion interconnecting the rim portion and a hub attachment portion to be connected to an axle, with the deformable narrow spoke potions provided with a thin, deformable parts covering approximately middle part of the disk radial portion.

2. (canceled)

3. The vehicle wheel of claim 1, wherein the deformable narrow spoke portions of the cover have an inside surface shape to come into contact with a covered surface of the outside surface of the disk radial portion covered with the deformable narrow spoke portions.

4. The vehicle wheel of claim 3, wherein the deformable narrow spoke portions have side edges to come into contact with a covered surface of the disk radial portion.

5. The vehicle wheel of claim 1, wherein the disk radial portion of the wheel base unit is shaped to be raised axially outward.
